(19) United States
(12) Patent Application Publication
(10) Pub. No.: US 2007/0069074 A1
(43) Pub. Date: Mar. 29, 2007

(54) CANOPY SYSTEM

(76) Inventor: David McDowell, Dundonald (IE)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/530,978

(22) Filed: Sep. 12, 2006

(30) Foreign Application Priority Data
Sep. 14, 2005 (GB) 0518733.1

(51) Int. Cl. B64C 1/10

(52) U.S. Cl. 244/121

(57) ABSTRACT

In one aspect, the invention is a canopy system, and in particular a canopy system to be deployed about and above a building site or the like, in order to provided weather proofing thereto. The canopy system includes a base of telescopic supports and a canopy support by and above the supports. The canopy is remotely extendable and retractable.

### FIELD OF THE INVENTION

The present invention is concerned with a canopy system, and in particular a canopy system for use in the building industry to provide cover to a building site or the like in order to enable work to continue during adverse weather conditions.

### BACKGROUND

In the building trade, estimates suggest that, depending on the type of building site, and the location of same, as much as four to five months worth of work may be lost due to adverse weather conditions. While extreme cases of weather, such as torrential rain or heavy sleet and/or snow may close a building site for a number of hours/days, even moderate weather conditions, while not resulting in the temporary closure of a site, can significantly slow the progress of work at the site. For example, while moderate rain or other weather conditions may not preclude the progress of certain operations on a site, other operations may be slowed or prevented, such as for example the pouring of concrete. This may then have a knock on affect, resulting in a significant drop in productivity. Such losses are both time consuming and costly, but are often unavoidable. Such interference due to weather is not of course limited to building sites.

It is therefore an object of the present invention to reduce or eliminate the above mentioned problems in order to maintain the progress of work on a building site or the like, regardless of the prevailing weather conditions.

It is a further object of the present invention to provide a means of sheltering a building site or the like from such adverse weather conditions.

It is a still further object of the present invention to provide a system which is adaptable to the changing landscape of a building site during the development thereof.

### SUMMARY OF THE INVENTION

The present invention therefore provides a canopy system comprising a height adjustable base; and a canopy at least partially supportable by and above the base.

Preferably, the base comprises at least a pair of height adjustable supports.

Preferably, each support is at least partially telescopic.

Preferably, the base is adapted to enable the canopy to be supported, in use, an inclined angle to the horizontal.

Preferably, the canopy is displaceable between an extended position and a retracted position.

Preferably, the system further comprises a cross member from which the canopy is displaceable between the extended and retracted positions.

Preferably, the cross member comprises a roller onto which the canopy may be wound and unwound to effect the retraction and extension, respectively, of the canopy.

Preferably, the system comprises at least one vent in the canopy.

Preferably, the system comprises means to effect the powered height adjustment of the base or a part thereof.

Preferably, the system comprises means to effect the remote displacement of the canopy between the extended and retracted positions.

Preferably, the system comprises a gutter locatable, in use, along at least one edge of the canopy.

Preferably, the system comprises at least one sidewall.

Preferably, each support comprises a platform projecting from which is a telescopic upright.

Preferably, the base may be hydraulically and/or pneumatically extended and retracted to effect the height adjustment thereof.

Preferably, the or each sidewall is ventilated.

As used herein, the term “canopy” is intended to mean a covering or roof that provides shade or other shelter, and is preferably substantially impervious to precipitation such as rain and/or snow, and which is preferably also flexible in order to allow the canopy to be wound and unwound onto a roller or the like. The canopy may be formed from a single sheet of material, or may be a combination of a number of individual elements which may or may not be independently manipulated.

As used herein, the term “telescopic” is intended to mean the ability of a component such as a support or similar upright to be extended and retracted in length, in particular along a longitudinal axis. This telescoping may be achieved in the conventional manner of two or more cylindrical elements housed concentrically within one another, and extendable outwardly in sequence. Alternatively the telescoping may be achieved by means of two or more elements arranged adjacent one another and displaceable relative to one another, for example by slidably mounting the two elements to one another via a guideway or the like, although any other suitable arrangement may be provided which is capable of effecting this telescoping action.

### BRIEF DESCRIPTION OF THE DRAWINGS

The present invention will now be described with reference to the accompanying drawings, in which;

FIG. 1 illustrates a perspective view of a building site, at which a preferred embodiment of a canopy system according to the present invention is partially erected;

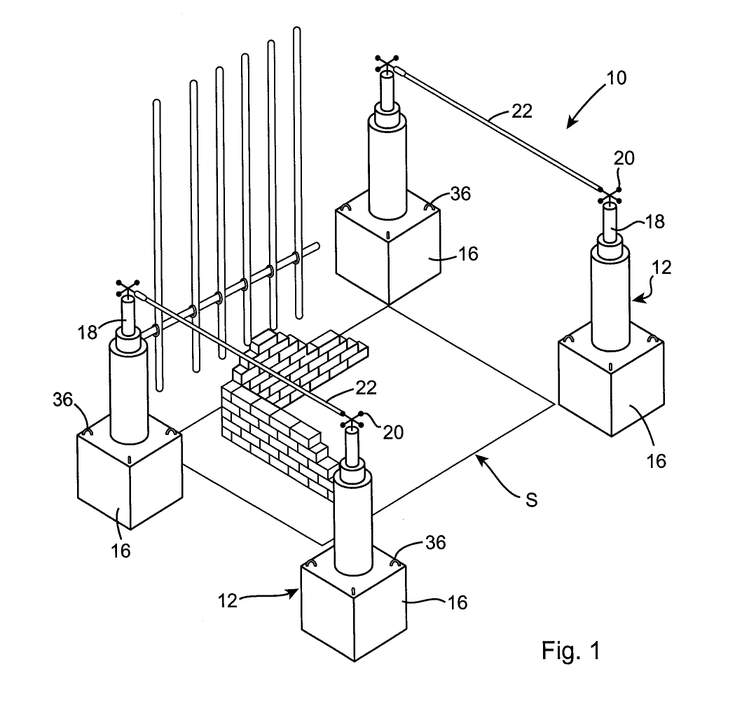

FIG. 2 illustrates the building site of FIG. 1, at which the canopy system of the present invention is fully erected, and disposed at a first height with a canopy of the system in a partially extended/retracted state; and

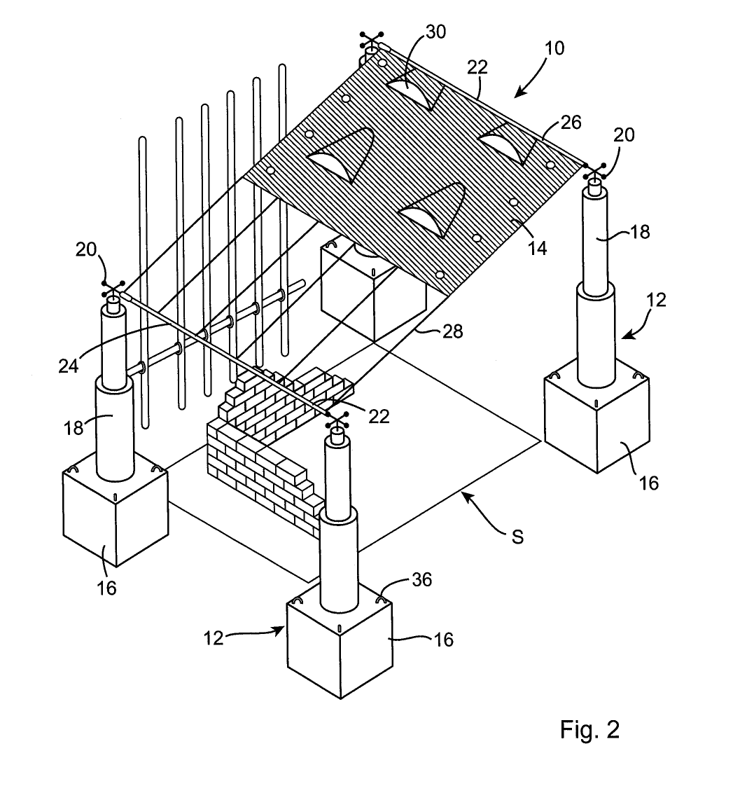

FIG. 3 illustrates the canopy system of FIG. 2, disposed at a second height above the building site, with the canopy in a fully extended or deployed position providing shelter to the area located therebeneath.

### DETAILED DESCRIPTION

Referring now to the accompanying drawings, there is illustrated a canopy system, generally indicated as 10, for providing cover from the elements, in particular precipitation such as rain, sleet or snow, to a building site S at which work is being undertaken. The system 10 therefore allows work to continue on the site S regardless of the weather conditions, thereby enabling consistent work at a site S all year round. It will of course be understood from the following description that the canopy system 10 of the present invention may be used at any number of other locations, and the example of a building site is used here for illustrative purposes only.

The canopy system 10 comprises, in the preferred embodiment illustrated, a height adjustable base in the form a plurality of, for example four, supports 12 which are disposed, in use, in spaced relation to one another, and which are adapted, as will be described hereinafter in detail, to support and retain a canopy 14 therebetween. The canopy 14 is preferably formed from a relatively flexible material or combination of materials, for example polyurethane or other plastic sheeting, or canvas treated to provide a waterproof coating or the like thereto. The supports 12 are located, in the preferred embodiment, such as to each define a corner of the canopy system 10, although it will be appreciated that any other suitable configuration may be employed. In particular, the geography of a site at which the system 10 is to be deployed may dictate the positioning of one or more of the supports 12.

Each support 12 comprises a base 16 and an upright in the form of a telescopic pole 18 extending, in use, upwardly therefrom. As will be described in greater detail hereinafter, the telescopic poles 18 allow the height of each of the supports 12 to be varied, thereby allowing the canopy 14 to be raised and lowered, in addition to enabling the inclination of the canopy 14 to be adjusted. In the preferred embodiment illustrated, each of the poles 18 comprises three telescoping sections housed concentrically within one another, although it will of course be understood that this arrangement may be varied, and is simply an exemplary embodiment. For example, depending on the range of heights to be achieved by the system 10, the number of sections forming each pole 18 may be increased or decreased as necessary.

In the preferred embodiment illustrated, each base 16 is formed from concrete or similarly heavy material, such as to provide ballast to the support 12, in order to provide stability to the system 10, in particular during adverse weather conditions such as strong rain or heavy wind. It will be appreciated that the base 16 of each support 12 may be of any other suitable form which provides such stability, for example by being adapted to be actively secured to the ground, for example using tethering, bolting, or any other suitable means.

Alternatively, the base 16 could be provided as a hollow structure which, once on site and positioned where required for full deployment of the system 10, may be filled with a flowable ballast such as water or sand or the like. Such an arrangement would render the system 10 lighter and thus more manoeuvrable for transport and deployment on site.

As a further alternative, the base 16 could be replaced with a simple plate or platform (not shown) secured to the underside of the telescopic pole 18, and having an area or footprint larger than the pole 18. For example the plate (not shown) could be a square shaped piece of steel plate, having a length of side roughly twice the diameter of the pole 18. In this way, once the support 12 was located in the correct position, with the steel plate sitting flat on the ground, ballast such as a palette of bricks (not shown) or the like could then be lowered onto the plate in order to anchor the support 12 in position. This arrangement again reduces the overall weight of each support 12, and utilises ballast already present on a building site, such as bricks or other masonry blocks, to secure the support 12 in place. A combination of the above alternatives could of course be employed if desired.

Located at the free end of each of the telescopic poles 18 is a coupling 20, in order to allow the connection of a cross member 22 between each pair of supports 12 as illustrated. The coupling 20 may be of any suitable mechanical configuration. In use, the canopy 14 is stretched between the pair of cross members 22, such that the cross members 22 essentially define a lower edge 24 and an upper edge 26 of the canopy 14 when fully deployed. At least one of the cross members 22 is preferably mounted on a pair of bearings/bushings (not shown) or the like, in order to allow the respective cross member 22 to be rotated about a longitudinal axis thereof. In this way, the upper or lower cross member 22 may be employed as a spool or roller onto and off of which the canopy 14 may be wound, in order to effect the extension/retraction of same. The respective cross member 22 is preferably adapted to be driven by displacement means, for example in the form of an electric/hydraulic/pneumatic motor or the like, in order to enable the remote extension/retraction of the canopy 14. It is of course possible that a manual system, such as a hand operated winch type arrangement (not shown) could be used to extend and retract the canopy 14. However, as the canopy 14 is likely, in use, to be raised to significant heights off the ground, it is preferable, from a practical and safety perspective, that the canopy 14 is remotely displaceable by means of a motor or the like.

The system 10 further includes, in the preferred embodiment illustrated, a number of cables 28 which, in use, are strung between the pair of cross members 22, in order to provide additional support to the canopy 14. The canopy 14 may be provided with a plurality of suitably positioned eyelets (not shown) or similar guides on the underside of the canopy 14, through which the cables 28 may therefore be threaded. Such an arrangement will prevent the canopy 14 from billowing away from the cables 28 during heavy wind or the like, while still allowing the canopy 14 to be wound onto and off of either of the cross members 22. Additionally or alternatively, the canopy could be provided with a number of stiffening batons (not shown) removably locatable in dedicated pockets (not shown) provided in the canopy 14, similar to those used to stiffen the sails of boats. It is preferable that such batons are removable from the canopy 14 in order to allow the canopy 14 to be retracted without impediment.

In order to further reduce the possible displacement of the canopy 14 in windy conditions, and therefore reduce the load which may be transferred from the canopy 14 to the supports 12, the canopy 14 is provided with a plurality of vents 30 formed integrally therewith, which vents 30 are preferably collapsible. These vents 30 allow wind to be vented through the canopy 14 in order to prevent the canopy 14 acting as a sail. The vents 30 are however shaped and dimensioned to prevent the ingress of precipitation through the canopy 14. It will be appreciated that, during use, the canopy 14 is preferably disposed at an angular orientation as illustrated in the accompanying drawings, by staggering the height to which the various supports 12 are raised. By sloping the canopy 14 at an angle to the horizontal, it will ensure that precipitation incident on the canopy 14 will run downwardly and off the canopy 14, as opposed to pooling thereon.

The system 10 is thus preferably provided with a gutter 32 which is mountable adjacent the lower edge 24 of the canopy 14, in order to collect rainwater running off the canopy 14. Extending downwardly from the gutter 32 is a conventional drainpipe 34, which may be connected to any suitable drain or other run off arrangement. It will of course be appreciated that the gutter 32 and drain pipe 34 could be omitted from the system 10, although this would result in a considerable run off of water from the lower edge 24 of the canopy 14, which in most situations would be likely to cause problems for the site S located beneath the canopy 14.

The canopy system 10 may also be provided with one or more sidewalls (not shown) which may be secured in any suitable manner, and in particular between pairs of the supports 12. These sidewalls (not shown) will provide addition protection to the site S, and may cover an entire side of the system 10, or may extend only partially down or across any given side of the system 10. As with the canopy 14, each of the sidewalls may be extendable and retractable, and again preferably by means of a motor or the like. The sidewalls (not shown) may also be provided with one or more vents (not shown) formed therein, to reduce the affect strong winds will have on same.

Thus in use the system 10 is erected at the site S as follows. Each of the supports 12 is positioned at a suitable location just beyond the area of the site S to be covered, and therefore protected, by the canopy 14. Once positioned, each support 12 may be further secured in position by means of one or more tethers (not shown), which may be secured to the respective support 12 by means of a plurality of hoops 36 formed integrally therewith. However, for most applications, the weight of the base 16 of each support 12 will be sufficient to ensure the structural integrity of the system 10.

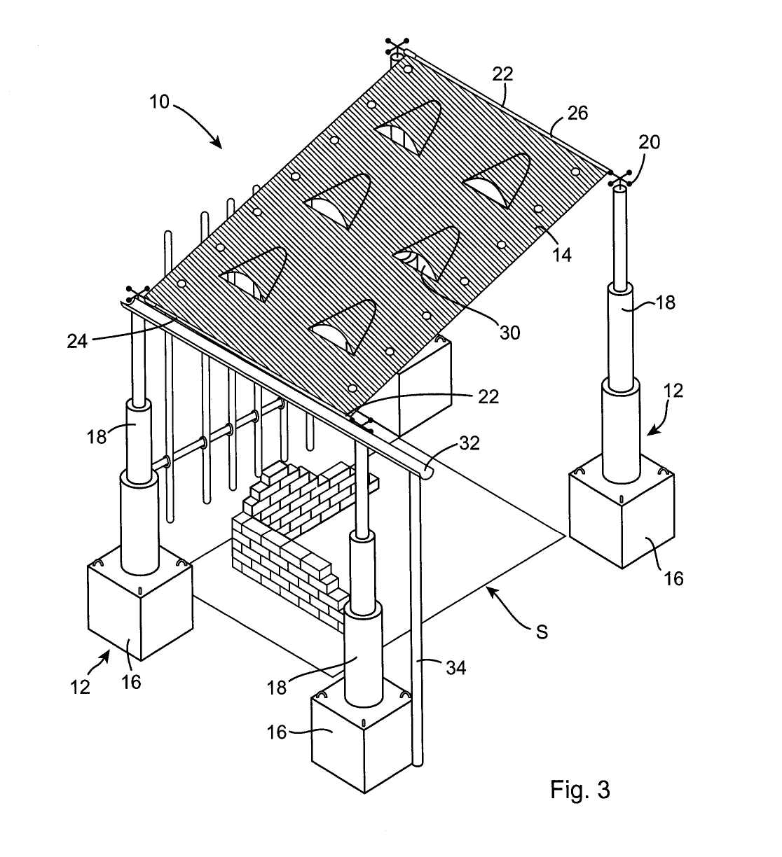

Once each of the supports 12 are located and secured in position, the poles 18 are then raised to a height which will give the canopy 14 a suitable inclination from the upper edge 26 down to the lower edge 24, as hereinbefore described, while also providing sufficient room between the canopy 14 and the ground or working surface of the site S to allow the necessary building operations to be conducted without impediment. At this point the canopy 14, which is in the fully retracted position during erection of the system 10, in deployed into the fully extended position as illustrated in FIG. 3, in order to provide coverage from the elements. The system 10, and in particular the supports 12, may be secured to any suitable existing structure, for example scaffolding as illustrated in the drawings, in order to further stabilise the system 10.

If a multi-storey building is being constructed on the site S, the system 10 is initially installed such that the canopy 14 is disposed at a height which will allow work on the ground floor to be completed without impediment. Once the ground floor work has been completed, and the next storey is to be started, the poles 18 are telescopically extended in order to raise the height of the canopy 14 to a level which will allow work on the second storey to be conducted without impediment. This process can be continued until the multi-storey building has been completed. For very tall buildings, the system 10 could be dismantled once it's maximum reach had been achieved, and then transported onto the top of the building, to be re-erected thereon to continue to provide weather protection to the exposed top of the building.

The extension and retraction of the poles 18 may be achieved manually, or more preferably by means of a motor such as an electric motor, or by a hydraulic/pneumatic motor (not shown) or the like. Likewise, the rolling and unrolling of the canopy 14 about one or other of the cross members 22 is preferably achieved using a motor (not shown) or the like, in order to allow this operation to be carried out remotely. The telescopic poles 18 are preferably configured to operate in the manner of a pneumatic/hydraulic ram, whereby pressurised air or oil may be used in order to effect the controlled extension of same. By allowing the air/oil to subsequently bleed from the pole 18, the weight of the canopy 14 will result in the retraction of the pole 18. The canopy system 10 preferably comprises control equipment (not shown) via which the synchronised raising/lowering of the various poles 18 may be achieved.

During day to day operations at any building site, in particular when dealing with multi-storey buildings, it is often necessary to transport materials such as bricks, timber, etc., via crane directly to the uppermost floor of the building. When such a delivery is required, the canopy 14 is simple retracted, whether fully or partially, to temporarily facilitate access to the site from above, via which a crane can then deliver a payload. Once delivery is complete, the canopy 14 is again returned to the fully extended position to resume coverage of the site.

The canopy system 10 may also be adapted to be partially secured to, and so supported by, an existing building or the like, adjacent which building work is being undertaken. For example, if an extension such as a conservatory or a garage is being added to an existing house, the house may then be used to secure one edge 24/26 of the canopy 14, thereby reducing the number of supports 12 required. In particular, the edge 24/26 of the canopy 14 may be secured under and to a facsia board (not shown), or any other suitable fixing point, of the house, and the other edge 24/26 supported by a pair of the supports 12 as hereinbefore described, positioned the necessary distance from the house to allow the canopy 14 to fully cover the site.

The system 10 of the present invention therefore provides a simple yet highly effective means of providing weather protection to a building site S or the like, in order to allow work to continue thereon regardless of the prevailing weather conditions. The system 10 may of course by used in other situations, for example in the hospitality sector, to provide a customisable shelter for use as a covered outdoor smoking area or the like.

1. A canopy system comprising a height adjustable base; and a canopy at least partially supportable by and above the base.

2. A canopy system according to claim 1 in which the base comprises at least a pair of height adjustable supports.

3. A canopy system according to claim 2 in which each support is at least partially telescopic.

4. A canopy system according to claim 1 in which the base is adapted to enable the canopy to be supported, in use, at an inclined angle to the horizontal.

5. A canopy system according to claim 1 in which the canopy is displaceable between an extended position and a retracted position.

6. A canopy system according to claim 1 comprising a cross member from which the canopy is displaceable between the extended and retracted positions.

7. A canopy system according to claim 6 in which the cross member comprises a roller onto which the canopy may be wound and unwound to effect the retraction and extension, respectively, of the canopy.

8. A canopy system according to claim 1 comprising at least one vent in the canopy.

9. A canopy system according to claim 1 comprising means to effect the powered height adjustment of the base or a part thereof.

10. A canopy system according to claim 1 comprising means to effect the remote displacement of the canopy between the extended and retracted positions.

11. A canopy system according to claim 1 comprising a gutter locatable, in use, along at least one edge of the canopy.

12. A canopy system according to claim 1 comprising at least one sidewall.

13. A canopy system according to claim 2 in which each support comprises a platform projecting from which is a telescopic upright.

14. A canopy system according to claim 1 in which the base may be hydraulically and/or pneumatically extended and retracted to effect the height adjustment of the base.
